(19) United States
(12) Patent Application Publication
(10) Pub. No.: US 2024/0211793 A1
(43) Pub. Date: Jun. 27, 2024

(54) FEATURE MAP DECOMPOSITION AND OPERATOR DECOMPOSITION IN MACHINE LEARNING OPERATIONS

(71) Applicant: QUALCOMM Incorporated, San Diego, CA (US)

(72) Inventors: Duseok KANG, Suwon-si (KR); Yunseong LEE, Gimpo-si (KR); Yeonseok KIM, Bucheon-si (KR); Lee JOOSEONG, Seoul (KR); Kyu Woong HWANG, Daejeon (KR)

(21) Appl. No.: 18/069,719

(22) Filed: Dec. 21, 2022

(51) Int. Cl. G06N 20/00; G06F 18/213; G06F 18/2451

(52) U.S. Cl. CPC G06N 20/00; G06F 18/213; G06F 18/2451

(57) ABSTRACT

Certain aspects of the present disclosure provide techniques for processing streaming data using machine learning models. An example method generally includes generating a first feature map for a first set of streaming data using a machine learning model. To generate the first feature map, results of one or more operations performed on each respective item in the first set of streaming data are combined into the first feature map, and the results of the one or more operations performed for each respective item in the first set of streaming data are combined into the first feature map. A second feature map is generated for a second set of streaming data using the machine learning model. A result of processing the total set of data through the machine learning model is generated based at least on a combination of the first feature map and the second feature map.

### INTRODUCTION

Aspects of the present disclosure relate to machine learning, and more particularly, to processing streaming data using machine learning models.

Machine learning models, such as artificial neural networks (ANNs), convolutional neural networks (CNNs), or the like, can be used to perform various actions on input data. These actions may include, for example, data compression, pattern matching (e.g., for biometric authentication), object detection (e.g., for surveillance applications, autonomous driving, or the like), natural language processing (e.g., identification of keywords in spoken speech that triggers execution of specified operations within a system), or other inference operations in which models are used to predict something about the state of the environment from which input data is received. In some cases, these machine learning models may continually receive data against which inferences are to be performed.

In some cases, machine learning models may use an input of a given size in order to produce an output. For example, a machine learning model may perform operations on a fixed number of samples captured over a period of time, such as a number of audio samples over an amount of time corresponding to a number of words spoken by a user (assuming, for example, an average tempo at which users speak, which may differ for users speaking different languages), a number of video frames over an amount of time sufficient to detect motion in a scene, or the like. Because machine learning models may wait for a sufficient amount of data in order to generate an output from this data, latencies may be introduced between the time at which a machine learning model receives streaming, or time-series, data for processing and the time at which the machine learning model has a sufficient amount of data to process. Further, inefficiencies may be introduced from processing overlapping data in different sets of streaming data, such as different data sets with elements that overlap in the time domain (e.g., are present in multiple time windows).

Accordingly, techniques are needed for efficient processing of streaming data using machine learning models.

### BRIEF SUMMARY

Certain aspects provide a method for processing streaming data using machine learning models. An example method generally includes generating a first feature map for a first set of streaming data using a machine learning model. The first set of streaming data generally includes a first portion of a total set of data to be processed through the machine learning model. To generate the first feature map, one or more operations are performed on each respective item in the first set of streaming data, and the results of the one or more operations performed for each respective item in the first set of streaming data are combined into the first feature map. A second feature map is generated for a second set of streaming data using the machine learning model, the second set of streaming data comprising a second portion of the total set of data. A result of processing the total set of data through the machine learning model is generated based at least on a combination of the first feature map and the second feature map.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of various aspects of the present disclosure and are therefore not to be considered limiting of the scope of this disclosure.

FIG. 1 depicts an example timeline for processing streaming data using a machine learning model.

FIG. 2 depicts an example timeline for incremental processing of streaming data using a machine learning model.

FIG. 3 illustrates an example of processing streaming data using operator decomposition, according to aspects of the present disclosure.

FIGS. 4A-4D illustrates an example of processing streaming data using a machine learning model via feature map decomposition and operator decomposition, according to aspects of the present disclosure.

FIG. 5 depicts a timeline of operations performed to process streaming data using a machine learning model via feature map decomposition and operator decomposition, according to aspects of the present disclosure.

FIG. 6 illustrates example operations for processing streaming data using a machine learning model via feature map decomposition and operator decomposition, according to aspects of the present disclosure.

FIG. 7 illustrates example implementations of a processing system on which streaming data can be processed using a machine learning model via feature map decomposition and operator decomposition, according to aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for efficiently processing streaming data using machine learning models.

Various applications use machine learning models to process streaming data and generate outputs which can subsequently be used to perform various specified actions within a system. For example, streaming audio data can be captured and processed by a machine learning model to authenticate or otherwise identify a user of a system (e.g., where multiple users, having different voice profiles, use the same system, and the system is customized based on the identity of the user). In another example, streaming video data can be captured and processed by a machine learning model to identify objects within a scene captured by a camera; identify the distance of these objects to a reference datum point; detect, track, and/or predict motion of these objects; and perform other identification and ranging tasks (e.g., for autonomous driving tasks, surveillance, and the like). In still further examples, time-series signal measurements (e.g., of channel quality information (CQI), channel state information (CSI), or the like) in wireless communications systems can be processed by a machine learning model for various predictive signal and/or beam management techniques, such as predicting beamforming patterns to use for communications between a network entity (e.g., a base station) and a user equipment (UE).

Many machine learning models can be used to process streaming data. To generate a usable output, these machine learning models typically receive some suitable amount of data as input to begin the inference process. For example, these machine learning models may operate using fixed amounts of data (e.g., a fixed number of frames of video, a fixed number of audio samples, samples captured over a defined amount of time, etc.). Because these machine learning models operate using fixed amounts of data and may not operate using null data, latencies may be introduced between when data capture is initiated and when an initial inference can be performed. Additionally, an initial amount of data to be processed by the machine learning models may be sized such that a significant amount of computation is to be performed for this initial amount of data prior to processing subsequent portions of data. Further, if the initial amount of captured streaming data does not result in an output that triggers execution of a specified action, data sets including subsequently received data can be processed using the machine learning models until an output that triggers execution of the specified action is generated. However, subsequent processing may use overlapping data present in both an older set of data and a newer set of data, which may result in processing cycles and memory being wasted in processing data that was previously processed using the machine learning models.

Aspects of the present disclosure provide techniques for efficiently processing streaming data using machine learning models. As discussed in further detail herein, to efficiently process streaming data using machine learning models, feature map decomposition and operator decomposition can be used to reduce the amount of data received before data can be processed by a machine learning model and to allow for operations to be decomposed into simpler operations that can be more efficiently and quickly executed. As discussed in further detail herein, feature map decomposition may allow for streaming data to be processed using a machine learning model using different portions of streaming data and combining the results of processing each portion of the streaming data into an overall result for the entirety of the streaming data, and operator decomposition may allow for computationally complex operations for each portion of streaming data to be decomposed into. By doing so, aspects of the present disclosure may reduce latency between receiving streaming data and processing such data. Further, aspects of the present disclosure may reduce the computational complexity of various operations using machine learning models, as operations can be performed on smaller amounts of data (e.g., lower-dimensionality matrices) with reduced or minimal redundancy. This, in turn, may reduce the amount of power used to process data using machine learning models and correspondingly provide for increased battery life on battery powered devices, such as smartphones, tablets, Internet of Things (IOT) devices, and the like, and reduce the amount of heat dissipated while processing data using machine learning models.

### Example Streaming Data Processing Using Machine Learning Models

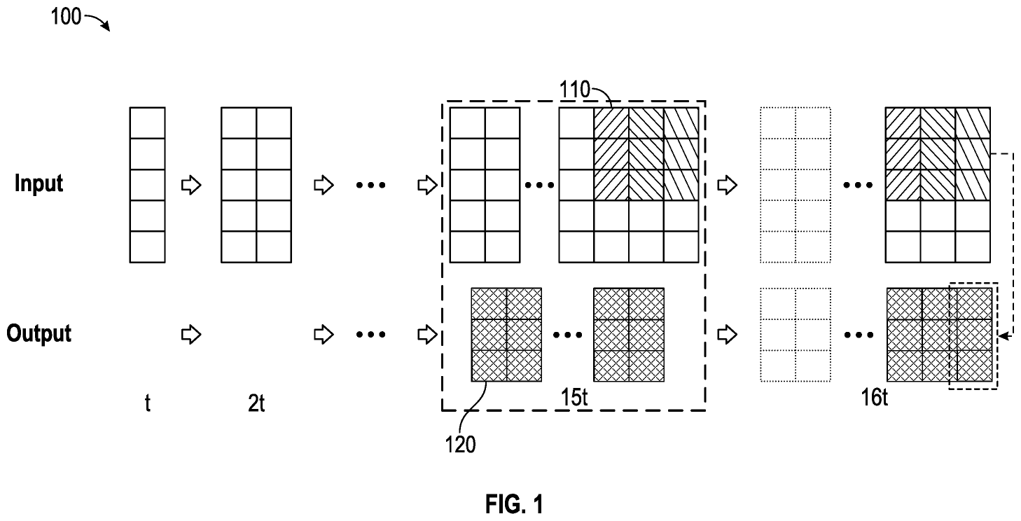

FIG. 1 depicts an example timing diagram 100 for processing streaming data using a machine learning model. For simplicity, each event occurs at a time denoted as some multiple of time t (e.g., t, 2t, 3t, . . . , nt). Each event generally represents a time at which an event, such as reception/transmission of an element of streaming data or a time at which computational operations are performed on the streaming data. Although FIG. 1 illustrates uniform time intervals (e.g., t=10 ms) between events, time intervals between events can have varying durations. In addition, though FIG. 1 illustrates input data 110 and output feature map 120 as matrices, input data 110 can be a vector, a matrix, a tensor, or the like, and output feature map 120 can be a vector, a matrix, or a tensor accordingly, based on the hyperparameters defined for the machine learning model (e.g., dimensions of the filter used, stride, paddings, etc.). For simplicity, the following discussion assumes a set of hyperparameters that specifies a 3×3 filter, a stride of 1 and no padding. Further, while FIG. 1 illustrates input data 110 in terms of two-dimensional data, it should be recognized that data of any dimensionality (e.g., visual data in two spatial dimensions with multiple data channels, such as color channels, alpha channels, etc.; audio data in the temporal and frequency dimensions; and the like) may be processed using the machine learning model.

The machine learning model generally processes input data 110 to generate an output feature map 120. In some examples, input data 110 is also a feature map. However, after the first event (at time t) only the first portion of input data 110 (represented as a first column of input data 110) is received, and there may not be sufficient data for the machine learning model to process. Similarly, after the second event (at time 2t), only the first two portions of input data 110 are received, and there may still not be sufficient data for the machine learning model to process. In fact, for certain aspects, the machine learning model may only begin processing input data 110 after the final data is received at time 15t.

Generally, the computational cost of processing data using machine learning models while waiting for a set amount of data to be received may be represented by the equation: (n−W+1)×W, where n represents the total size of the input data 110 and W represents the size of the window over which input data is processed. In some cases, when input data 110 is sufficiently large, processing the input data 110 using a machine learning model may be a computationally expensive process. Thus, a significant amount of time may elapse between receiving the last element of input data 110 and generating output feature map 120. For example, as illustrated, the output feature map 120 may not be generated until time 16t. For large values of t, this may mean that a processing system may be unable to perform other tasks for a significant amount of time, or may only be able to devote limited amounts of compute resources to other operations, which may delay the completion of those other operations and otherwise be a source of computational bottlenecks that can cause cascading delays to the completion of tasks executing on a processing system. These delays in processing streaming data may be exacerbated when the windows over which streaming data is processed overlap with each other. In such a case, data may be processed multiple times using the machine learning model, which may result in duplication of work and may unnecessarily delay completion of data processing operations using the machine learning model. In some applications, such as autonomous driving, other safety-critical applications, or other applications in which real-time processing is utilized to perform a task, these delays may make it difficult to perform the task within the timing constraints for successful execution of the task.

### Example Streaming Data Processing Using Machine Learning Models and Feature Map Decomposition

To reduce latencies involved in processing streaming data using machine learning models, streaming input data may be processed using feature map decomposition in which the results generated for previously received input data are retained, and input data is processed as such data is received.

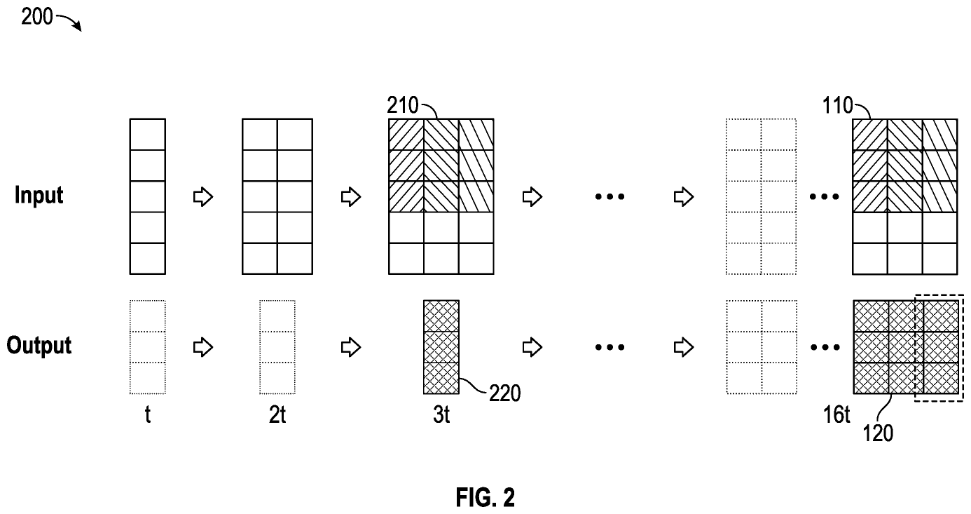

FIG. 2 depicts an example timing diagram 200 for processing streaming data using a machine learning model and feature map decomposition. For simplicity, as in FIG. 1, each event occurs at a time denoted as some multiple of 1. Each event can represent reception/transmission of data and/or computation of received data. Although FIG. 2 illustrates uniform time intervals (e.g., t=10 ms) between events, time intervals between events can have varying durations. In addition, though FIG. 2 illustrates input data 110 and output feature map 120 as matrices, input data 110 can be a vector, a matrix, or a tensor, and output feature map 120 can be a vector, a matrix, or a tensor accordingly, based on the hyperparameters for the convolution (e.g., dimensions of the filter used, stride, paddings, etc.).

Similar to FIG. 1, the entirety of input data 110 may be received at a final point in time. However, prior to reception of the final element of input data 110, feature map decomposition allows some operations to be performed on already received portions of input data 110 to distribute the computational load over time. For example, assume that input data 110 has 15 elements in total and that feature map decomposition allows for data to be processed in groups of 3 elements. By using feature map decomposition to process the streaming data, processing can begin earlier (e.g., at time 3t in this example) with partial input data 210 instead of at time 15t as described above with respect to FIG. 1. Therefore, at least a portion of output feature map 120 can be generated before the final element of input data 110 is received.

In some examples, the dimensions of the filter are used to determine the part of output feature map 120 generated for any given portion of input data 110 and the amount of data from input data 110 used to generate each part of output feature map 120. The portion of input data 110 with compatible dimensions for the filter can be used as input into the machine learning model for processing. In this example, a 3×3 filter is used for illustration, though some other filter dimensions can also be applicable.

Given the 3×3 filter, computation can start when partial input data 210 is received at time 3t. In this example, partial input data 210 includes the first 3 columns of input data 110. Accordingly, the 3×3 filter can be applied to the 5×3 partial input data 210 to generate a 3×1 vector. The 3×1 vector generated is partial output feature map 220, which, as illustrated, corresponds to the first column of output feature map 120.

Accordingly, following the example above, at time 4t, columns 2-4 of input data 110 can be used to generate the second column of output feature map 120 by applying the 3×3 filter. The second column of output feature map 120 can be concatenated with (e.g., appended to) the partial output feature map 220 (the first column of output feature map 120) to form the first two columns of output feature map 120. Similarly, after the final element of input data 110 is received at time 15t, the last three columns of input data 110 can be used to generate the last column of output feature map 120 by applying the 3×3 filter, and the last column of output feature map 120 can be concatenated with the previously generated columns of output feature map 120.

Although the end of computation timing (16t) illustrated in FIG. 1 is shown as the same as the end of computation timing of timing diagram 100 shown in FIG. 1, the computational expense of processing smaller amounts of data may allow for the completion of processing input data 110 at a significantly earlier point of time than as illustrated in FIG. 1. For example, in contrast to the computational expense of (n−W+1)×W for processing streaming input data according to the techniques discussed above with respect to FIG. 1, the computational expense of processing input data using feature map decomposition may correspond to n, or the size of input data 110. However, in the example illustrated in FIG. 2, computation may be significantly “front-loaded.” That is, a significant amount of data may be processed early in the process, and subsequent data processing operations may be performed on significantly smaller amounts of data. However, the computational expense of processing an initial amount of data may not allow for a machine learning model to comply with application-specific constraints (e.g., timing, memory utilization, etc.) and may thus prevent these machine learning models from being deployed for use in various applications.

### Example Streaming Data Processing

In some aspects, complex operations performed on streaming input data can be decomposed into a plurality of simpler operations. By decomposing a larger, complex operation into a plurality of less computationally complex operations, a complex operation can be performed more efficiently and with lower computational overhead, which may in turn allow for the use of a machine learning model to process streaming input data while complying with timing and resource constraints imposed by the application for which the machine learning model and the outputs generated by the machine learning model are used.

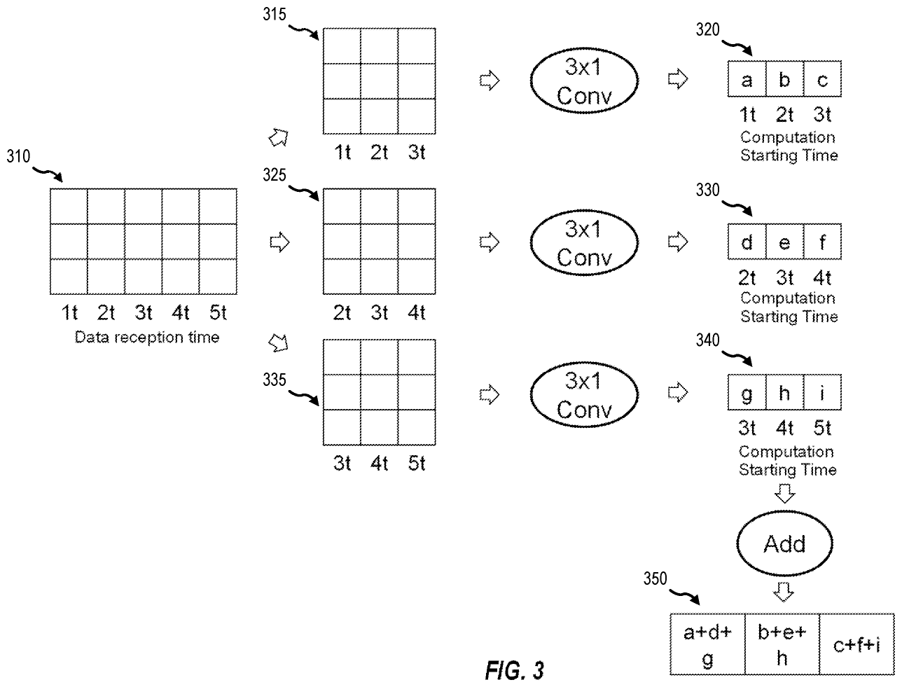

FIG. 3 illustrates an example of processing streaming data using operator decomposition, according to aspects of the present disclosure. Although FIG. 3 illustrates input data 310 as a matrix and output feature maps 320, 330, and 340 as vectors, input data 310 can be a vector, a matrix, or a tensor, and output feature maps 320, 330, and 340 can be a vector, a matrix, or a tensor, based on the hyperparameters for the convolution (e.g., dimensions of the filter used, stride, paddings, etc.). In addition, though input data 310 is illustrated as a 3×5 matrix and output feature maps 320, 330, and 340 as a 1×3 vector, other dimensions are possible for input data 310 and output feature map 320.

The 5×3 input data 310 can undergo convolution to generate the 1×3 output feature map 320, with the discussed hyperparameters that specify a 3×3 filter, a stride of 1, and no padding, as illustrated.

In this example, to process input data 310 using feature map decomposition and operator decomposition, input data 310 may be illustrated as data having been received at different reception times {1t, 2t, 3t, 4t, 5t}. A first set of streaming data 315 (corresponding to data arriving during a first time window), for which a feature map 320 is generated, may represent the input data received at times 1t, 2t, and 3t; a second set of streaming data 325 (corresponding to data arriving during a second time window), for which a feature map 330 is generated, may represent the input data received at times 2t, 3t, and 4t; and a third set of streaming data 335 (corresponding to data arriving during a third time window), for which a feature map 340 is generated, may represent the input data received at times 3t, 4t, and 5t. To generate a result 360 of convolution operations on the input data 310, the feature maps 320, 330, and 340 may be processed using a 3×1 convolution on the first set of streaming data 315, second set of streaming data 325, and third set of streaming data 335, respectively. The output feature maps 320, 330, and 340 may be added together to generate an aggregate output feature map 360, representing the results of applying a convolution filter to input data 310.

For example, as illustrated, output feature map 320 includes elements “a,” “b,” and “c,” representing the results generated by applying a 3×1 convolutional filter to the first set of streaming data 315. Similarly, output feature map 330 includes elements “d,” “e,” and “f,” representing the results generated by applying a 3×1 convolutional filter to the second set of streaming data 325, and output feature map 340 includes elements “g,” “h,” and “i,” representing the results generated by applying a 3×1 convolutional filter to the third set of streaming data 325. In adding output feature maps 320, 330, and 340 together into aggregate output feature map 360, corresponding indices in output feature maps 320, 330, and 340 may be aggregated into a sum. Thus, as illustrated, aggregate output feature map 360 may include three elements: the sum of elements “a,” “d,” and “g” (e.g., the sum of the first element in each of output feature maps 320, 330, and 340); the sum of elements “b,” “e,” and “h” (e.g., the sum of the second element in each of output feature maps 320, 330, and 340); and the sum of elements “c,” “f,” and “i” (e.g., the sum of the third element in each of output feature maps 320, 330, and 340).

As illustrated, thus, a larger convolution filter (e.g., a 3×3 filter) may be separated (e.g., decomposed) into a plurality of smaller filters (e.g., three 3×1 filters). In some examples, separable filters are objects that are one dimension lower than the original filter. For example, if the original filter is a two-dimensional object (e.g., a matrix), separable filters may in turn be one-dimensional objects (e.g., vectors). Separable filters can be implemented using a standard library, such as Keras separableConv2D.

By aggregating the results of convolutions using these plurality of smaller filters, aspects of the present disclosure may achieve the same results as performing a larger convolution with improvements in the time domain. For example, unlike convolutions in which processing begins when the entirety of input data 310 is received, decomposition of a larger convolution into multiple smaller convolutions may allow for convolution operations to be performed as a sufficient amount of data is received. The results of these multiple smaller convolutions may be aggregated into an aggregate output feature map that is the same as the result that would be generated using a larger convolutional filter, which may accordingly allow for a convolution operation to be completed in a shorter amount of elapsed time relative to the time at which the last element of input data 310 is received than if a larger convolution operation were performed after the last element of input data 310 is received.

### Example Processing Streaming Data Using Feature Map Decomposition and Operator Decomposition

To efficiently process streaming data using a machine learning model, aspects of the present disclosure combine feature map decomposition and operator decomposition to minimize, or at least reduce, latency and computational complexity in processing streaming data.

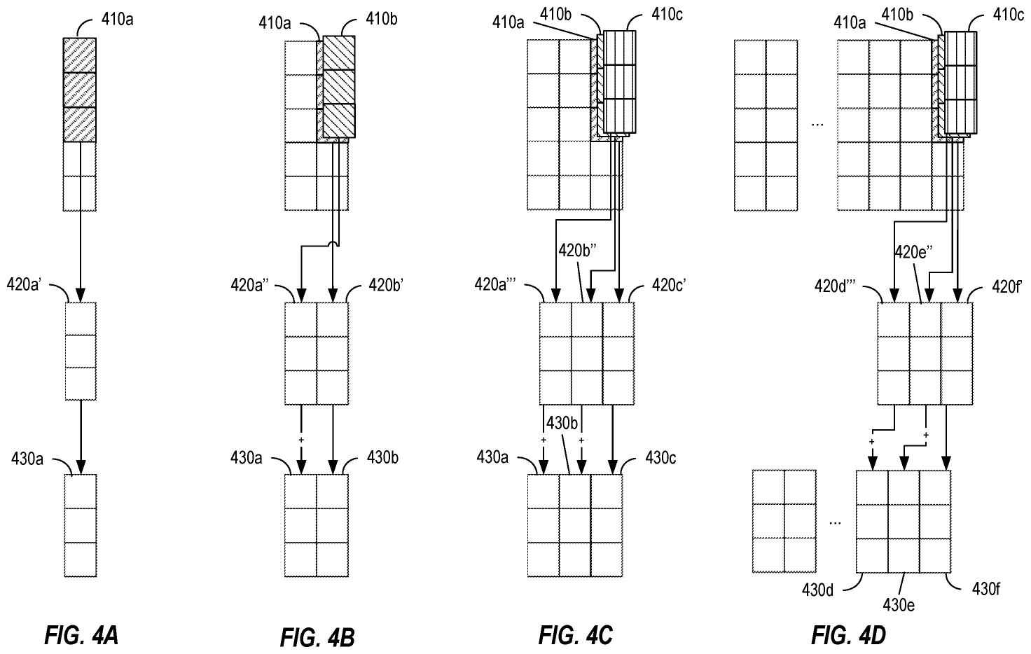

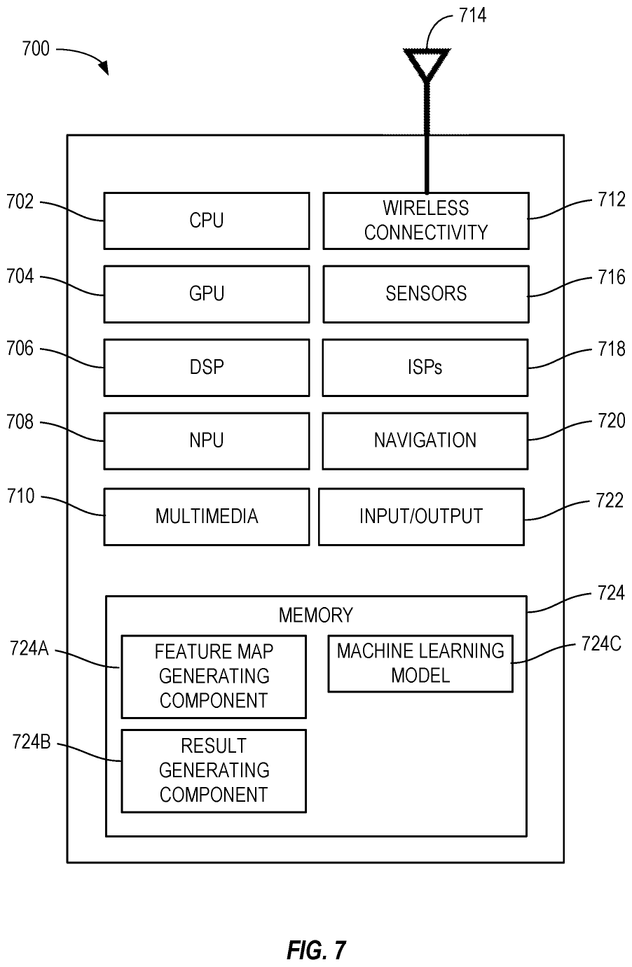

FIGS. 4A-4D depict example operations at four different points in time, corresponding to the reception of four pieces of input data in a streaming or sequential manner. The operations illustrated in FIGS. 4A-4D may be performed by a computing system, such as a user equipment (UE) or other computing device, such as that illustrated in FIG. 7, on which a machine learning model that can perform one or more operations (e.g., convolution, pooling, and/or linear operations) is deployed for use in processing streaming or sequential data, such as streaming audio or video data. Although FIGS. 4A-4D depict incremental convolution, it should be recognized that other operations (e.g., pooling, and/or linear operations) can be performed using similar techniques as those illustrated in FIGS. 4A-4D following the steps discussed in the computation.

FIG. 4A depicts an example incremental convolution operation at a first point in time. At the first point in time, data corresponding to column 410a is received. Column 410a can be a partial input (e.g., a subset of the entire input data), and can be a tensor, a matrix, or a vector compatible with the filter discussed above (e.g., the 3×3 filter). Accordingly, a 3×1 filter (e.g., a component of the 3×3 filter) can be applied to column 410a to generate partial output feature map 420a, and thus generate output 430a.

FIG. 4B depicts an example incremental convolution operation at a second point in time. At the second point in time, data corresponding to column 410b is received. Column 410b can be a partial input, similar to column 410a. In particular, column 410b is compatible with the previous partial input (e.g., column 410a) and the filter. Accordingly, the component 3×1 filter can be applied to column 410b to generate partial output feature map 420b. In this example, the results of convolving the input in column 410b may be added to the previous output 430a to update output 430a and generate output 430b.

As discussed above in FIG. 3C, the associated elements of a given piece of data in an output feature map reside in the previous two columns of a partial (or intermediate) output feature map, if those elements exist and are valid. In this example, partial output feature map 420a is a predecessor to partial output feature map 420b. Thus. partial output feature map 420b can be combined with partial output feature map 420a to form an updated output feature map. More specifically, each element (e.g., in each row) of partial output feature map 420a is associated with the corresponding element (e.g., in the corresponding row) of partial output feature map 420b. Partial output feature map 420a can be updated via addition (e.g., elementwise addition or weighted addition) with respect to partial output feature map 420b. For simplicity, the updated output feature maps in the following discussion retain their enumerations, respectively. For example, the updated output feature map 420a is still referred to as output feature map 420a. In addition, before or after the addition, partial output feature map 420b can be concatenated with (e.g., appended to as a new column) partial output feature map 420a. In some examples, combining partial output feature map 420b and partial output feature map 420a involves both addition and concatenation.

FIG. 4C depicts an example incremental convolution operation at a third point in time. At the third point in time, data corresponding to column 410c is received. Column 410c can be a partial input. In particular, column 410c is compatible with previous partial inputs (e.g., columns 410a-b) and the filter. Accordingly, the component 3×1 filter can be applied to column 410c to generate partial output feature map 420c. Partial output feature map 420c can be combined with partial output feature maps 420a-b to form an updated output feature map, using the steps discussed above. In this example, the results of convolving the input in column 410c may be added to the previous outputs 430a and 430b to update outputs 430a and 430b and generate output 430c.

Following the example above, in this example, both partial output feature maps 420a and 420b are predecessors to partial output feature map 420c. Accordingly, each element of partial output feature map 420a is added by the corresponding element of partial output feature map 420c, and similarly, each element of partial output feature map 420b is added by the corresponding element of partial output feature map 420c. The addition can be elementwise addition or weighted addition. In addition, before or after the addition, partial output feature map 420c can be concatenated with (e.g., appended to as a new column) partial output feature maps 420a-b. The updated output feature map can be a combination of combined partial output feature maps 420a-c.

FIG. 4D depicts an example incremental convolution operation at a fourth point in time. At the fourth point in time, data corresponding to column 410f is received, with data corresponding to columns 410d and 410e having previously been received after data in column 410c was received. Column 410f can be a partial input. In particular, column 410c is compatible with previous partial inputs (e.g., columns 410a-e) and the filter. Accordingly, the component 3×1 filter can be applied to column 410f to generate partial output feature map 420f. Partial output feature map 420f can be combined with partial output feature maps 420d-e to update outputs 430d and 430e and generate output 430f. However, because computation may have been completed for other columns of data outside of the window over which data is to be convolved, these outputs 430a-c may be left unaffected by the results of convolving the data corresponding to column 410f.

Following the example above, in this example, both partial output feature maps 420b and 420c are valid predecessor partial output feature maps to partial output feature map 420d, respectively, as the dimensionality of the component filter may not allow for partial output feature map 420a to also be a valid predecessor to partial output feature map 420d. Accordingly, each element of partial output feature map 420b is added by the corresponding element of partial output feature map 420d, and similarly, each element of partial output feature map 420c is added by the corresponding element of partial output feature map 420d. The addition can be elementwise addition or weighted addition. Also, before or after the addition, partial output feature map 420d can be concatenated with (e.g., appended to as a new column) partial output feature maps 420a-c. The updated output feature map can be the combined partial output feature maps 420a-d.

In some examples, the dimensions of the input data are known, and during incremental convolution, the dimensions of the output feature map can be determined before the computation starts, as discussed with respect to FIG. 3C.

In some examples, alternatively, the dimensions of the input data are not known, and after the incremental convolution, a subset of the updated output feature map that is compatible with the dimensions of input data and hyperparameters can be determined as the output feature map. In other words, redundant portions of the updated output feature map will be omitted in the output. In this example, if the input data is a 5×4 matrix (e.g., including columns 410a-d), and the hyperparameters are as discussed above (e.g., a 3×3 filter, a stride of 1, and no padding), only the first two columns of the updated output feature map (e.g., the updated partial output feature maps 420a-b) will be determined as the output feature map. Accordingly, the updated partial output feature maps 420c-d are redundant and will be discarded.

### Example Latency Reductions Through Processing Streaming Data Using Feature Map Decomposition and Operator Decomposition

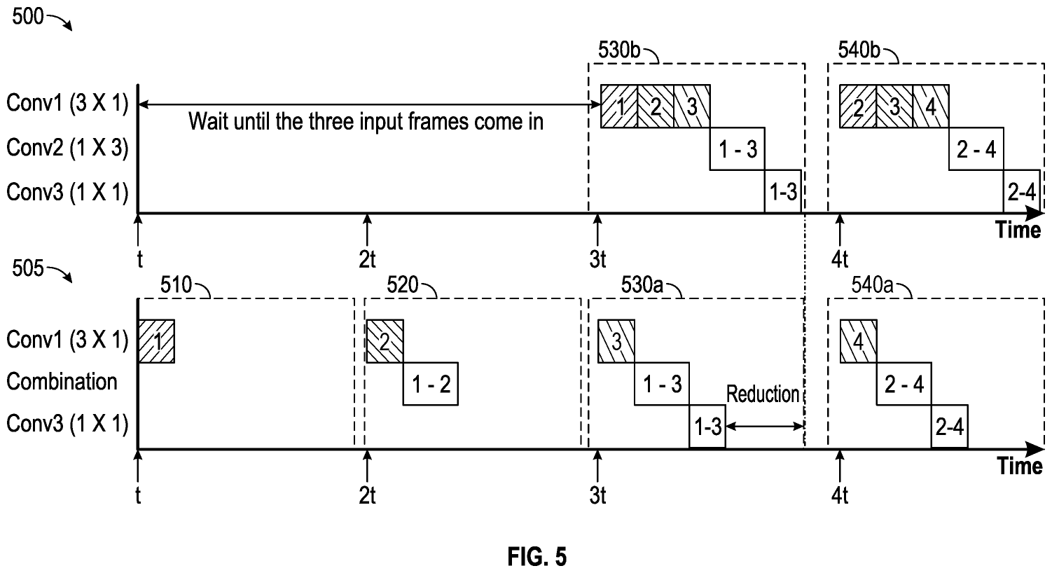

FIG. 5 depicts an example timing diagram 500 illustrating latency reductions which may be achieved by processing streaming data using a machine learning model that supports feature map decomposition and operator decomposition. Timing diagram 500 illustrates the timing of events for processing data using a machine learning model and feature map decomposition, while timing diagram 505 illustrates the timing of events for processing data using a machine learning model, feature map decomposition, and operator decomposition. As discussed above, processing data using feature map decomposition generally distributes the computational load and achieves lower latency between initial receipt of streaming data and generation of an output using a machine learning model than processing data without the use of feature map decomposition, in which a larger amount of data is to be received before such data can be processed using a machine learning model.

Timing diagrams 500 and 505 illustrate the timing of various operations performed by a machine learning model including one or more convolutional layers. In some examples, the timing diagram 500 illustrates the timing of operations performed using a group of convolutional layers in a machine learning model when the group of convolutional layers performs operations using feature map decomposition alone, whereas the timing diagram 505 illustrates the timing of operations performed using the same group of convolutional layers in the machine learning model but when the group of convolutional layers performs operations using both feature map decomposition and operator decomposition. While FIG. 5 illustrates timing with respect to convolutional operations in a machine learning model, it should be recognized by one of ordinary skill in the art that similar timings of operations may be achieved when processing streaming data using a machine learning model that includes other types of operations, including pooling operations, linear operations, and other operations that may be included in a machine learning model.

At block 510, after a first transmission (e.g., at time t), the machine learning model can perform convolution on a first part of input data (also called input frame 1) with a separable filter (e.g., the 3×1 filter discussed above) to generate output feature map 1, as illustrated. Input frame 1 can be a tensor, a matrix, or a vector having a dimension compatible with the separable filter.

Accordingly, at block 520, after a second transmission (e.g., at time 2t), the machine learning model can proceed to perform convolution on a second part of the input data (also called input frame 2) with a separable filter (e.g., the 3×1 filter discussed above) to generate output feature map 2, as illustrated. Input frame 2 can be a tensor, a matrix, or a vector having a dimension compatible with the separable filter and with the previous input frame (e.g., input frame 1). Further, the machine learning model can combine the output feature map 1 and output feature map 2, according to the incremental convolution operations discussed with respect to FIGS. 4A-D.

At block 530a, after a third transmission (e.g., at time 3t), the machine learning model can proceed to perform convolution on a third part of the input data (also called input frame 3) with a separable filter (e.g., the 3×1 filter discussed above) to generate output feature map 3, as illustrated. Input frame 3 can be a tensor, a matrix, or a vector having a dimension compatible with the separable filter and with previous input frames (e.g., input frames 1-2). Further, the machine learning model can combine the output feature maps 1-3, according to the incremental convolution operations discussed with respect to FIGS. 4A-D. In some examples, as illustrated, the machine learning model can, in block 530a, perform additional convolution with a 1×1 filter on the combined output feature maps 1-3. The convolution with the 1×1 filter can alter the number of parameters as desired.

Alternatively, if the machine learning model uses convolution with only feature map decomposition, starting at block 530b, after the third transmission (e.g., at time 3t), the first 3 input frames are received and are conjoined. The machine learning model can perform a first convolution on the conjoined first 3 input frames with a separable filter (e.g., the 3×1 filter discussed above) to generate an intermediate output feature map, and then perform a second convolution on the intermediate output feature map with a separable filter (e.g., the 1×3 filter discussed above) to generate an output feature map corresponding to input frames 1-3, similar to combined output feature maps 1-3. In some examples, the second convolution can be replaced by incremental convolution operations discussed with respect to FIGS. 4A-D. In some examples, as illustrated, the machine learning model can, in block 530b, perform additional convolution with a 1×1 filter on the output feature map corresponding to input frames 1-3.

As illustrated, the machine learning model finishes evaluation at block 530a earlier than at block 530b, and demonstrates that incremental convolution evaluates faster than convolution with only feature decomposition. The latency reduction (as shown through the dashed line) implies reduced computational load, and hence energy savings.

Following the discussion above, at block 540a, after a fourth transmission (e.g., at time 4t), the machine learning model can proceed to perform convolution on a fourth part of input data (also called input frame 4) with a separable filter (e.g., the 3×1 filter discussed above) to generate output feature map 4. The fourth input frame can be a tensor, a matrix, or a vector having a dimension compatible with the separable filter and with previous frames. Further, the machine learning model can combine output feature maps 2-4, according to the incremental convolution operations discussed with respect to FIGS. 4A-D. In some examples, as illustrated, the machine learning model can, in block 530a, perform additional convolution with a 1×1 filter on the combined output feature map 2-4.

Alternatively, if the machine learning model uses convolution with only feature map decomposition, at block 540b, after the fourth transmission (e.g., at time 4t), the input frames 2-4 are received and are conjoined. The machine learning model can perform a first convolution on the conjoined input frames 2-4 with a separable filter (e.g., the 3×1 filter discussed above) to generate an intermediate output feature map, and then performs a second convolution on the intermediate output feature map with a separable filter (e.g., the 1×3 filter discussed above) to generate an output feature map corresponding to input frames 2-4, similar to combined output feature maps 2-4. In some examples, the second convolution can be replaced by incremental convolution operations discussed with respect to FIGS. 4A-D. In some examples, as illustrated, the machine learning model can, in block 530b, perform additional convolution with a 1×1 filter on the output feature map corresponding to input frames 2-4.

In some examples, the combined output feature maps 1-3 and the combined output feature maps 2-4 can be combined to form a combined output feature maps 1-4, similar to as discussed with respect to FIGS. 4A-D.

As illustrated, the machine learning model finishes evaluation at block 540a earlier than at block 540b, showing another latency reduction.

### Example Streaming Data Processing Using Feature Map Decomposition and Operator Decomposition

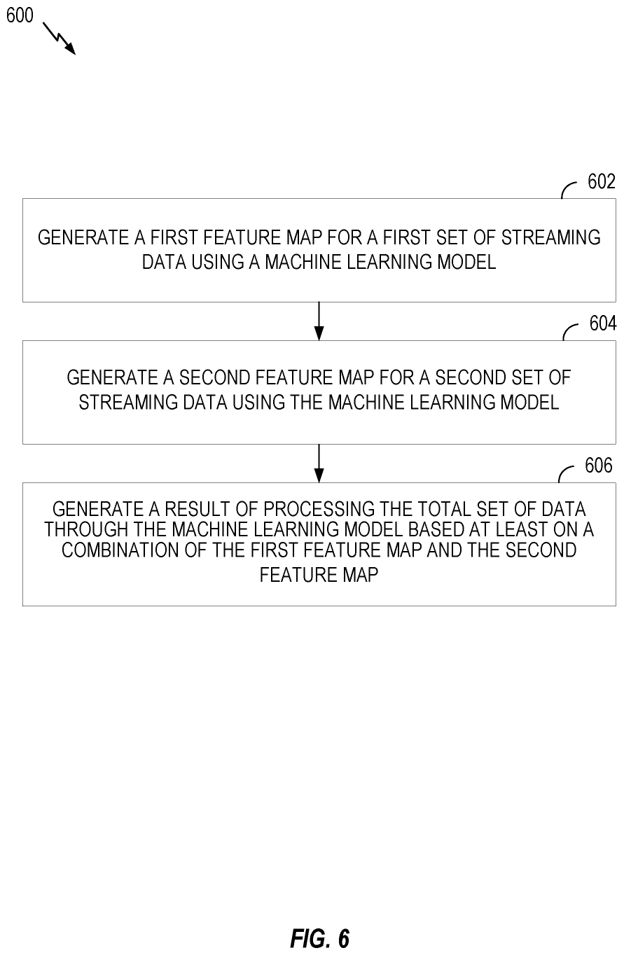

FIG. 6 depicts a flow diagram of example operations 600 for processing streaming data using a machine learning model via feature map decomposition and operator decomposition. Operations 600 can be performed, for example, by a computing system, such as a user equipment (UE) or other computing device, such as processing system 700 illustrated in FIG. 7, on which a machine learning model which can perform one or more operations (e.g., convolution, pooling, and/or linear operations) is deployed.

At block 602, as illustrated, operations 600 start with generating a first feature map for a first set of streaming data using a machine learning model. Generally, the first set of streaming data comprises a first portion of a total set of data to be processed through the machine learning model and may be received or accessed in sequence (e.g., with the first element in the first set of streaming data being received or accessed first, the second element in the first set of streaming data being received or accessed after the first element, the third element in the first set of streaming data being received or accessed after the second element, and so on). The first feature map may be generated by processing each respective item in the first set of streaming data. For any respective item, one or more operations are performed on the respective item. In some aspects, the one or more operations may be performed currently on different respective items in the first set of streaming data. The results of the one or more operations performed for each respective item in the first set of streaming data are combined into the first feature map.

At block 604, operations 600 proceed with generating a second feature map for a second set of streaming data using the machine learning model. The second feature map may be generated using similar techniques to those used to generate the first feature map, as discussed above. Generally, the second set of streaming data may partially overlap with the first set of streaming data such that the second set of streaming data shares some data with the first set of streaming data and includes other data not included in the first set of streaming data. For example, assuming that the first set of streaming data includes elements 1, 2, and 3, the second set of streaming data might include elements 2, 3, and 4 (though it should be recognized by one of skill in the art that the first set of streaming data and the second set of streaming data may include any number of elements, and any number of elements less than the total number of elements in each set of streaming data may be shared between the first set of streaming data and the second set of streaming data).

In some aspects, the machine learning model includes layers that can perform operations incrementally on different portions of data, such as one or more convolutional layers performing incremental convolution, one or more pooling layers performing incremental pooling, and/or one or more dense layers performing incremental linear operation, among other types of layers that can be deployed as part of a machine learning model. For example, the first set of streaming data can be input frames 1-3, as discussed in FIG. 5. Accordingly, each respective item in the first set of streaming data can be each of the input frames 1-3, and the first feature map can be the combined output feature maps 1-3, as discussed in FIG. 5. Similarly, the second set of streaming data can be input frames 2-4, as discussed in FIG. 5, and the second feature map can be the combined output feature maps 2-4.

In some aspects, the second set of streaming data comprises a portion of the first set of streaming data. As discussed above, the first set of streaming data can be each of the input frames 1-3, whereas the second set of streaming data can be input frames 2-4, such that the second set of streaming data can include a portion of the first set of streaming data (e.g., input frames 2-3) as discussed in FIG. 5.

At block 606, operations 600 proceed with generating a result of processing the total set of data through the machine learning model based at least on a combination of the first feature map and the second feature map. For example, the result of processing the total set of data, where the first set of streaming data corresponds to input frames 1-3 illustrated in FIG. 5 and the second set of streaming data corresponds to input frames 2-4 illustrated in FIG. 5, includes the combination of the output feature maps 1-4 illustrated in FIG. 5.

In some aspects, operations 600 may further include outputting the generated result.

In some aspects, operations 600 may further include taking one or more actions based on the generated result. The one or more actions may vary based on the application for which the machine learning model is deployed. For example, in an object detection task in autonomous vehicle operations, the one or more actions may include applying one or more control inputs to the autonomous vehicle to cause the vehicle to stop or steer around a detected object in the path along which the autonomous vehicle is traveling. In another example, in surveillance applications, the one or more actions may include identifying anomalous activity within a scene surveilled by one or more cameras and taking various actions based on the identification of such anomalous activity (e.g., locking entry points into a building, activating other protective systems, activating additional lighting, generating alerts, etc.). It should be recognized that these are but a few examples of various actions that can be taken based on a result of processing the total set of data through the machine learning model, and other actions associated with other environments in which the machine learning model is deployed and/or tasks for which the machine learning model is deployed may be taken based on the generated result of processing the total set of data.

In some aspects, generating the result of processing the total set of data comprises combining an element in the first feature map with a corresponding element in the second feature map into a combined result. For example, the element in the first feature map can be output feature map 1, and the corresponding element in the second feature map can be output feature map 2, as discussed in FIG. 5.

In some aspects, the results of the one or more operations performed for each respective item in the first set of streaming data corresponds to a result of a larger single operation performed on the first set of streaming data. For example, the larger single operation can be the standard operation (e.g., a convolution with the 3×3 filter, as discussed above with respect to FIG. 3A), whereas the one or more operations performed for each respective item can be the incremental operation (e.g., the convolution operations performed with the 3×1 filter and addition, as discussed above with respect to FIG. 3C).

In some aspects, each operation of the one or more operations comprises one or more convolutions performed via a two-dimensional (2D) convolution filter. For example, the 2D convolution filter may correspond to the component 3×1 filter illustrated in FIG. 3C, where the larger overall operation corresponds to a 3×3 filter illustrated in FIG. 3A.

In some aspects, each operation of the one or more operations comprises one or more convolutions performed via a convolution filter having dimensions specified via one or more hyperparameters. For example, the one or more hyperparameters can be the filter dimension, stride, and/or padding.

In some aspects, combining the results of the one or more operations performed for each respective item in the first set of streaming data comprises appending, to a result for a first item in the first set of streaming data, a result for a second item in the first set of streaming data, and updating the result for the first item based on the result for the second item. For example, the first item can be input frame 1, and the second item can be input frame 2, such that the result for the first item can be output feature map 1, and the result for the second item can be output feature map 2, as discussed in FIG. 5.

In some aspects, the first set of streaming data and the second set of streaming data have a same size.

In some aspects, a size of the first set of streaming data is based on a size of one or more convolutional layers of the machine learning model

In some aspects, performing the one or more convolutions comprises sequentially performing the one or more operations on different respective items in the first set of streaming data

In some aspects, the one or more operations performed for each respective item comprises incremental convolution, incremental pooling, or incremental linear operations.

### Example Processing System for Processing Streaming Data Using Feature Map Decomposition and Operator Decomposition

FIG. 7 depicts an example processing system 700 for processing streaming data using a machine learning model via feature map decomposition and operator decomposition, such as described herein for example with respect to FIG. 6.

Processing system 700 includes a central processing unit (CPU) 702, which in some examples may be a multi-core CPU. Instructions executed at the CPU 702 may be loaded, for example, from a program memory associated with the CPU 702 or may be loaded from a memory 724.

Processing system 700 also includes additional processing components tailored to specific functions, such as a graphics processing unit (GPU) 704, a digital signal processor (DSP) 706, a neural processing unit (NPU) 708, a multimedia processing unit 710, and a wireless connectivity component 712.

An NPU, such as 708, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this data piece through an already trained model to generate a model output (e.g., an inference).

In one implementation, NPU 708 is a part of one or more of CPU 702, GPU 704, and/or DSP 706.

In some examples, wireless connectivity component 712 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 712 is further connected to one or more antennas 714.

Processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

Processing system 700 may also include one or more input and/or output devices 722, such as screens, touch-sensitive surfaces (including touch-sensitive displays), physical buttons, speakers, microphones, and the like.

In some examples, one or more of the processors of processing system 700 may be based on an ARM or RISC-V instruction set.

Processing system 700 also includes memory 724, which is representative of one or more static and/or dynamic memories, such as a dynamic random access memory, a flash-based static memory, and the like. In this example, memory 724 includes computer-executable components, which may be executed by one or more of the aforementioned processors of processing system 700.

In particular, in this example, memory 724 includes feature map generating component 724A, result generating component 724B, and machine learning model 724C. The depicted components, and others not depicted, may be configured to perform various aspects of the methods described herein.

Generally, processing system 700 and/or components thereof may be configured to perform the methods described herein.

Notably, in other aspects, aspects of processing system 700 may be omitted, such as where processing system 700 is a server computer or the like. For example, multimedia processing unit 710, wireless connectivity component 712, sensor processing units 716, ISPs 718, and/or navigation processor 720 may be omitted in other aspects. Further, aspects of processing system 700 may be distributed, such as training a model and using the model to generate inferences, such as user verification predictions.

### Example Clauses

Clause 1: A computer-implemented method, comprising: generating a first feature map for a first set of streaming data using a machine learning model, wherein: the first set of streaming data comprises a first portion of a total set of data to be processed through the machine learning model, and generating the first feature map comprises: for each respective item in the first set of streaming data, performing one or more operations on the respective item; and combining results of the one or more operations performed for each respective item in the first set of streaming data into the first feature map; generating a second feature map for a second set of streaming data using the machine learning model, the second set of streaming data comprising a second portion of the total set of data and partially overlapping with the first set of streaming data; and generating a result of processing the total set of data through the machine learning model based at least on a combination of the first feature map and the second feature map.

Clause 2: The method of Clause 1, wherein the second set of streaming data comprises a portion of the first set of streaming data.

Clause 3: The method of Clause 1 or 2, wherein generating the result of processing the total set of data comprises combining an element in the first feature map with a corresponding element in the second feature map into a combined result for an input included in both the first set of streaming data and the second set of streaming data.

Clause 4: The method of any of Clauses 1 through 3, wherein the results of the one or more operations performed for each respective item in the first set of streaming data correspond to results of a larger single operation performed on the first set of streaming data.

Clause 5: The method of any of Clauses 1 through 4, wherein each operation of the one or more operations comprises one or more convolutions performed via a 2D convolution filter.

Clause 6: The method of any of Clauses 1 through 5, wherein each operation of the one or more operations comprises one or more convolutions performed via a convolution filter having dimensions specified via one or more hyperparameters.

Clause 7: The method of any of Clauses 1 through 6, wherein combining the results of the one or more operations performed for each respective item in the first set of streaming data comprises: appending, to a result for a first item in the first set of streaming data, a result for a second item in the first set of streaming data; and updating the result for the first item based on the result for the second item.

Clause 8: The method of any of Clauses 1 through 7, wherein the first set of streaming data and the second set of streaming data have a same size.

Clause 9: The method of any of Clauses 1 through 8, wherein a size of the first set of streaming data is based on a size of one or more convolutional layers of the machine learning model.

Clause 10: The method of any of Clauses 1 through 9, wherein performing the one or more operations comprises concurrently performing the one or more operations on different respective items in the first set of streaming data.

Clause 11: The method of any of Clauses 1 through 10, wherein the one or more operations comprise one or more pooling operations.

Clause 12: The method of any of Clauses 1 through 11, wherein the one or more operations comprise one or more linear operations.

Clause 13: A processing system comprising: a memory comprising computer-executable instructions; and one or more processors configured to execute the computer-executable instructions and cause the processing system to perform a method in accordance with any of Clauses 1-12.

Clause 14: A processing system, comprising means for performing a method in accordance with any of Clauses 1-12.

Clause 15: A non-transitory computer-readable medium comprising computer-executable instructions that, when executed by one or more processors of a processing system, cause the processing system to perform a method in accordance with any of Clauses 1-12.

Clause 16: A computer program product embodied on a computer-readable storage medium comprising code for performing a method in accordance with any of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
generating a first feature map for a first set of streaming data using a machine learning model, wherein:
the first set of streaming data comprises a first portion of a total set of data to be processed through the machine learning model, and
generating the first feature map comprises:
for each respective item in the first set of streaming data,
performing one or more operations on the respective item; and
combining results of the one or more operations performed for each respective item in the first set of streaming data into the first feature map;
generating a second feature map for a second set of streaming data using the machine learning model, the second set of streaming data comprising a second portion of the total set of data and partially overlapping with the first set of streaming data; and
generating a result of processing the total set of data through the machine learning model based at least on a combination of the first feature map and the second feature map.

2. The method of claim 1, wherein the second set of streaming data comprises a portion of the first set of streaming data.

3. The method in claim 1, wherein generating the result of processing the total set of data comprises combining an element in the first feature map with a corresponding element in the second feature map into a combined result for an input included in both the first set of streaming data and the second set of streaming data.

4. The method of claim 1, wherein the results of the one or more operations performed for each respective item in the first set of streaming data correspond to results of a larger single operation performed on the first set of streaming data.

5. The method of claim 1, wherein each operation of the one or more operations comprises one or more convolutions performed via a 2D convolution filter.

6. The method of claim 1, wherein each operation of the one or more operations comprises one or more convolutions performed via a convolution filter having dimensions specified via one or more hyperparameters.

7. The method of claim 1, wherein combining the results of the one or more operations performed for each respective item in the first set of streaming data comprises:
appending, to a result for a first item in the first set of streaming data, a result for a second item in the first set of streaming data; and
updating the result for the first item based on the result for the second item.

8. The method of claim 1, wherein the first set of streaming data and the second set of streaming data have a same size.

9. The method of claim 1, wherein a size of the first set of streaming data is based on a size of one or more convolutional layers of the machine learning model.

10. The method of claim 1, wherein performing the one or more operations comprises concurrently performing the one or more operations on different respective items in the first set of streaming data.

11. The method of claim 1, wherein the one or more operations comprise one or more pooling operations.

12. The method of claim 1, wherein the one or more operations comprise one or more linear operations.

13. A system, comprising:
a memory having executable instructions stored thereon; and
a processor configured to execute the executable instructions to cause the system to:
generate a first feature map for a first set of streaming data using a machine learning model, wherein:
the first set of streaming data comprises a first portion of a total set of data to be processed through the machine learning model, and
in order to generate the first feature map, the processor is configured to cause the system to:
perform, for each respective item in the first set of streaming data, one or more operations on the respective item; and
combine results of the one or more operations performed for each respective item in the first set of streaming data into the first feature map;
generate a second feature map for a second set of streaming data using the machine learning model, the second set of streaming data comprising a second portion of the total set of data and partially overlapping with the first set of streaming data; and
generate a result of processing the total set of data through the machine learning model based at least on a combination of the first feature map and the second feature map.

14. The system of claim 13, wherein the second set of streaming data comprises a portion of the first set of streaming data.

15. The system in claim 13, wherein in order to generate the result of processing the total set of data, the processor is configured to cause the system to combine an element in the first feature map with a corresponding element in the second feature map into a combined result for an input included in both the first set of streaming data and the second set of streaming data.

16. The system of claim 13, wherein the results of the one or more operations performed for each respective item in the first set of streaming data correspond to results of a larger single operation performed on the first set of streaming data.

17. The system of claim 13, wherein each operation of the one or more operations comprises one or more convolutions performed via a 2D convolution filter.

18. The system of claim 13, wherein each operation of the one or more operations comprises one or more convolutions performed via a convolution filter having dimensions specified via one or more hyperparameters.

19. The system of claim 13, wherein in order to combine the results of the one or more operations performed for each respective item in the first set of streaming data, the processor is configured to cause the system to:
append, to a result for a first item in the first set of streaming data, a result for a second item in the first set of streaming data; and
update the result for the first item based on the result for the second item.

20. The system of claim 13, wherein the first set of streaming data and the second set of streaming data have a same size.

21. The system of claim 13, wherein a size of the first set of streaming data is based on a size of one or more convolutional layers of the machine learning model.

22. The system of claim 13, wherein in order to perform the one or more operations, the processor is configured to cause the system to concurrently perform the one or more operations on different respective items in the first set of streaming data.

23. The system of claim 13, wherein the one or more operations comprise one or more pooling operations.

24. The system of claim 13, wherein the one or more operations comprise one or more linear operations.

25. A system, comprising:
means for generating a first feature map for a first set of streaming data using a machine learning model, wherein:
the first set of streaming data comprises a first portion of a total set of data to be processed through the machine learning model, and
the means for generating the first feature map comprises:
means for performing, for each respective item in the first set of streaming data, one or more operations on the respective item; and
means for combining results of the one or more operations performed for each respective item in the first set of streaming data into the first feature map;
means for generating a second feature map for a second set of streaming data using the machine learning model, the second set of streaming data comprising a second portion of the total set of data and partially overlapping with the first set of streaming data; and
means for generating a result of processing the total set of data through the machine learning model based at least on a combination of the first feature map and the second feature map.

26. The system of claim 25, wherein the means for generating the result of processing the total set of data comprises means for combining an element in the first feature map with a corresponding element in the second feature map into a combined result for an input included in both the first set of streaming data and the second set of streaming data.

27. The system of claim 25, wherein the results of the one or more operations performed for each respective item in the first set of streaming data correspond to results of a larger single operation performed on the first set of streaming data.

28. The system of claim 25, wherein the means for combining the results of the one or more operations performed for each respective item in the first set of streaming data comprises:
means for appending, to a result for a first item in the first set of streaming data, a result for a second item in the first set of streaming data; and
means for updating the result for the first item based on the result for the second item.

29. The system of claim 25, wherein the means for performing the one or more operations comprises means for concurrently performing the one or more operations on different respective items in the first set of streaming data.

30. A non-transitory computer-readable medium having instructions stored thereon which, when executed, cause a processor to perform a method comprising:
generating a first feature map for a first set of streaming data using a machine learning model, wherein:
the first set of streaming data comprises a first portion of a total set of data to be processed through the machine learning model, and
generating the first feature map comprises:
for each respective item in the first set of streaming data,
performing one or more operations on the respective item; and
combining results of the one or more operations performed for each respective item in the first set of streaming data into the first feature map;
generating a second feature map for a second set of streaming data using the machine learning model, the second set of streaming data comprising a second portion of the total set of data and partially overlapping with the first set of streaming data; and
generating a result of processing the total set of data through the machine learning model based at least on a combination of the first feature map and the second feature map.
